(19) United States
(12) Patent Application Publication
(10) Pub. No.: US 2004/0224646 A1
(43) Pub. Date: Nov. 11, 2004

(54) Data loading device for mobile phones

(76) Inventor: Hyon S. Bae, Burlinggame, CA (US)

Correspondence Address: JACOBSON HOLMAN, PLLC, THE JENIFER BUILDING, 400 SEVENTH STREET, N.W., WASHINGTON, DC, 20004-2201, US

(21) Appl. No.: 10/431,779

(22) Filed: May 8, 2003

(51) Int. Cl. H04Q 7/20

(52) U.S. Cl. 455/90.3

(57) ABSTRACT

A portable data loading device for transferring data to and from a mobile phone is described and claimed. The portable data loading device includes a housing and a board within the housing. The board contains a data storage device for storing data and a microcontroller for controlling the transfer of data to and from the mobile phone. The portable data loading device also includes a selection mechanism in communication with the board for selecting between the transfer of data to the mobile phone from the portable data loading device or the transfer of data from the mobile phone to the portable data loading device. An input/output port is also included in the portable data loading device to directly engage the portable data loading device to the mobile phone.

### BACKGROUND OF THE INVENTION

1. Field of the Invention

The present invention generally relates to mobile phones, and more particularly, to a portable data transferring device that transfers information between the portable data transferring device and a mobile phone, as well as between the portable data transferring device and other data devices.

2. Description of the Related Art

Mobile phones, e.g. cellular phones, are continuously being increased in use throughout the world. People are relying more and more on their mobile phones as their primary phone at home, work or in between. With the increased use and popularity of mobile phones, individuals have spent a lot of time customizing the mobile phone to store very personalized information on the phones, including names, addresses, phone numbers, pre-defined groups, screen savers, speed dialing capabilities and other features and applications offered by phones for customization.

With quite frequency, individuals change their mobiles phones. For a variety of reasons, this change occurs quite often, on average of about once a year. The reasons for changing phones are numerous. For example, an individual may wish to upgrade to a newer phone or may want to start a new phone service plan. Also, a current phone may be lost or damaged.

A problem exists for individuals that want to retain all the customized information stored in a mobile phone upon changing to a new phone. This is because individuals are forced to re-enter all information into the new phone unless the phone information has been backed up on some other back up device such as a computer. But backing up phone information on a computer is a complicated process. It requires custom software on the computer that is needed to interact with particular models of phones to download information and store that information on the computer. It requires constant downloading since a phone may be lost or damaged at any time. It requires a skilled individual who is comfortable with computers and comfortable with ways of interfacing computers with external devices. This process is complex by requiring software, a computer and establishing a connection between the computer and the phone to download and store data. In addition, this prior solution requires the old phone to be used, which is not possible if the phone is lost or damaged.

The problem is exacerbated by the fact that many individuals who own mobile phones may not have a computer or may not have the requisite expertise to properly back up the phones using customized software. A need exists for a simple, reliable way for all individuals to easily backup customized information on their mobile phones.

Another solution has been to remove certain Subscriber Identification Module (SIM) cards (that contain the personalized information) located in a current phone and place that card into a new phone to store all the prior information in the new phone. However, this process again assumes that an old phone has not been lost or damaged that renders the old SIM card unusable. This solution also assumes that the new phone is compatible with the SIM card from the prior phone. Also, the act of opening a phone and removing a SIM card is not easy. Still further, almost half of mobile phones do not contain SIM cards.

Another problem with using a computer to backup information on the mobile phone is that the computer is large and bulky, (including laptops) and does not allow an individual to easily backup information at any time since the computer is not portable in all situations. A need therefore exists for a more portable solution allowing an individual to backup information more frequently and at any location.

Still further, all prior solutions have been for mere backup of information of data on mobile phone to a computer. There is also a need to transfer data between two phones, not only to back up data onto a computer. This process becomes even more complex since the second phone would have to be interfaced with the first phone and the computer to transfer the information. A more portable solution would allow data transfer of contact information between two individuals at any time, much like the exchange of a physical business card, without the use of a computer.

A need therefore exists for a device and method that provide a simple, reliable, portable and cost-efficient manner of storing data from a mobile phone for the transfer of that data to a new mobile phone, to other mobile phones or even other devices such as personal digital assistants and the like.

### SUMMARY OF THE INVENTION

The present invention provides for a portable data loading device for transferring data to and from a mobile phone. The portable data loading device includes a housing and a board within the housing. The board contains a data storage device for storing data and a microcontroller for controlling the transfer of data to and from the mobile phone. The portable data loading device also includes a selection mechanism in communication with the board for selecting between the transfer of data to the mobile phone from the portable data loading device or the transfer of data from the mobile phone to the portable data loading device. An input/output port is also included in the portable data loading device to directly engage the portable data loading device to the mobile phone.

### BRIEF DESCRIPTION OF THE DRAWINGS

A more complex appreciation of the invention and many of the advantages thereof will be readily obtained as the same becomes better understood by references to the detailed description when considered in connection with the accompanying drawings, wherein:

FIG. 1 is a perspective view of an embodiment of the portable data loading device of the present invention;

FIG. 2 is a perspective view of a further embodiment of the portable data loading device of the present invention;

FIG. 3 is a perspective view of an embodiment of the portable data loading device of the present invention in use with a mobile phone;

FIG. 4 is a perspective view of a disassembled embodiment of the portable data loading device of the present invention;

FIG. 5A is a top view of an embodiment of the board of the portable data loading device of the present invention;

FIG. 5B is a side view of an embodiment of the board of the portable data loading device of the present invention; and

FIG. 5C is a bottom view of an embodiment of the board of the portable data loading device of the present invention.

### DETAILED DESCRIPTION OF THE PREFERRED EMBODIMENT

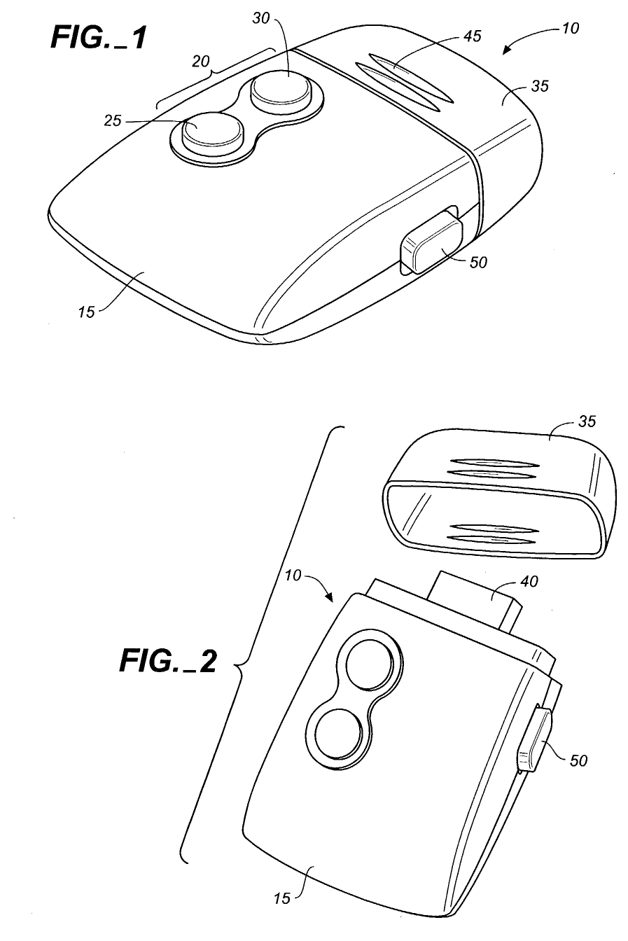

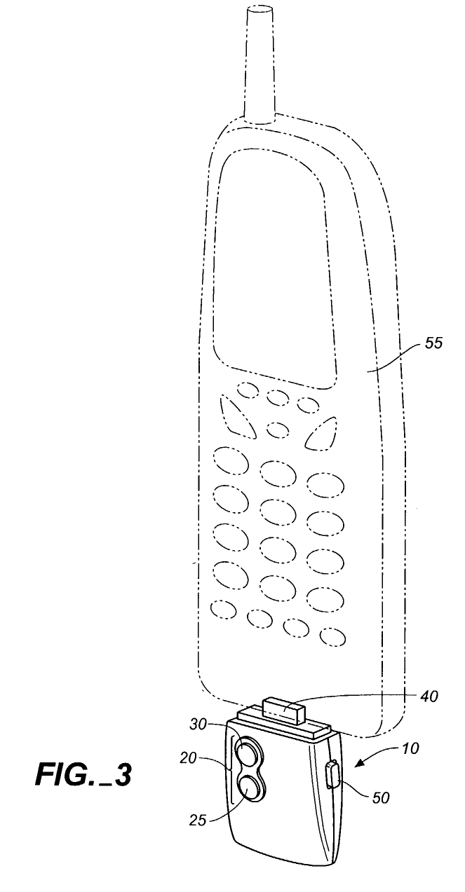

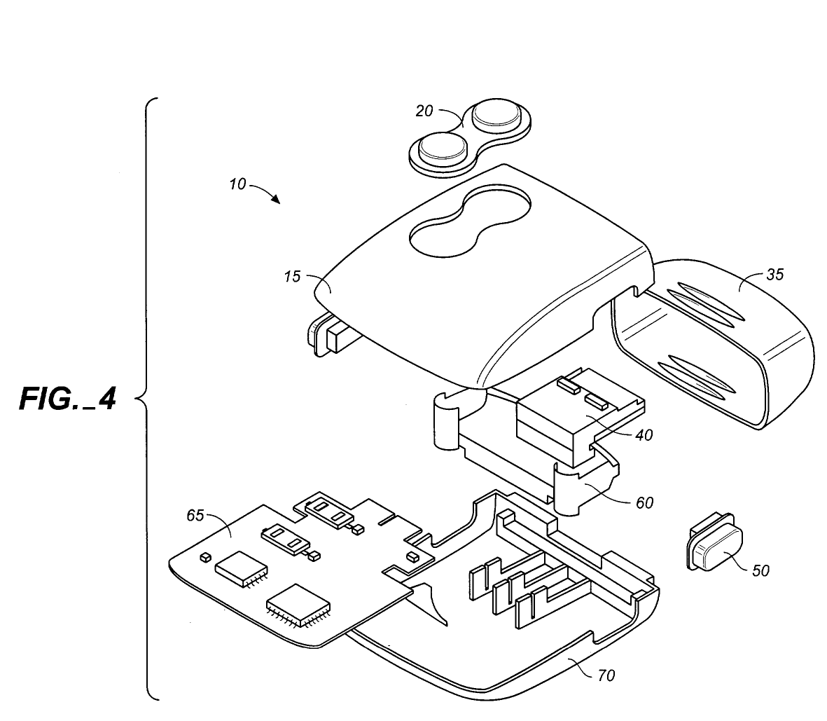

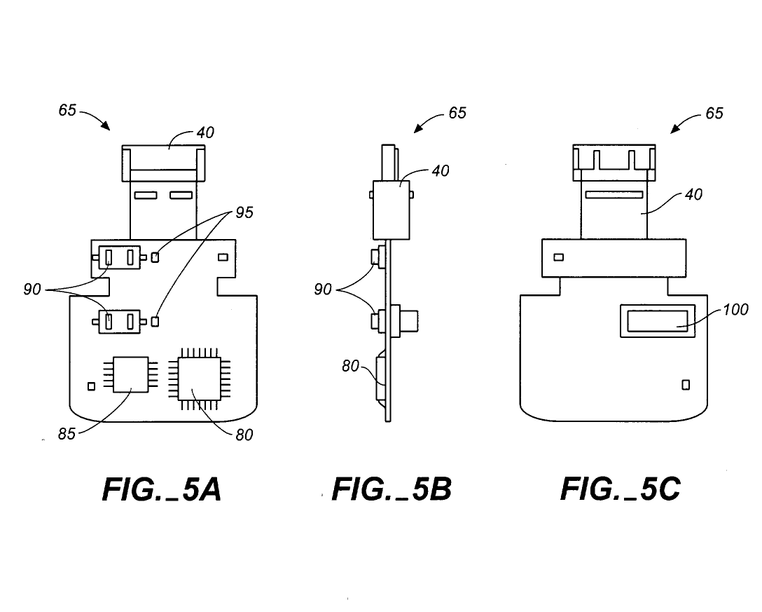

FIG. 1 is a perspective view of an embodiment of the portable data loading device of the present invention. In FIG. 1, an embodiment of the portable data loading device 10 is shown. The embodiment has a housing 15 that contains the components and circuitry described in FIGS. 4 and 5A-C below. The housing 15 may be a variety of materials, including, for example, injection-molded plastic, metal, metal alloys or other materials that may contain devices that receive and transmit data. The portable data loading device 10 also has selection mechanism 20 that, in this embodiment, is in the form of a pair of buttons, a first button 25 and a second button 30. The selection mechanism 20 serves to select between one of two functions achieved by the portable data loading device 10: the function of transferring data to a mobile phone that is connected to the portable data loading device 10 or the function of transferring data from the mobile phone to the portable data loading device 10. The first 25 and second 30 buttons thereby serve a convenient and simple function of allowing a user to depress either button depending on the function desired. Thus, if a user wishes to transfer data from the portable data loading device 10 to a mobile phone, the user would press one of the buttons to transfer data off a storage device within the portable data loading device 10. Should the user wish to transfer data to the portable data loading device 10 from a mobile phone, then the user would depress the other button. It is noted that this embodiment uses two buttons to achieve the functions of loading data on or off the portable data loading device 10. Other embodiments may use other selection mechanisms to achieve these two functions. For example, a single button may be used on the portable data loading device 10 that can differentiate between the transfer of data to the mobile phone from the transfer of data from the mobile phone by distinguishing between different sequences applied to the single button. For example, a first sequence may be based on the amount of time that the user holds down the single button. Thus, the portable data loading device 10 may have a single button (i.e. selection mechanism in this embodiment) that may be depressed for an amount of time that is distinguishable (e.g. by length of time that the button is depressed) from an amount of time of depressing the single button during a second sequence. Similarly, the first sequence for the single button may be distinguished from the second sequence based on the number of times that the single button is depressed. For example, a single depression of the single button, in one embodiment, may cause the data to be transferred from the portable data loading device 10 to the mobile phone. Then a double depression of the single button may cause the data to be transferred from the mobile phone to the portable data loading device 10. It is noted that the data transferred between the portable data loading device and the mobile phone may be any type of data typically stored on a mobile phone or a portable digital device. In one embodiment, the data includes user-defined information such as names, addresses, phone numbers. The data may also include mobile phone information such as the mobile phone serial number and custom settings for the phone (e.g., ringers, games, screen savers or wallpapers). Returning to FIG. 1, it is noted that the size of the portable data loading device 10 is very small. In one embodiment, the dimensions of the portable data loading device is 20 mm×30 mm×15 mm. This compact size of the device 10 allows the device 10 to be highly advantageous to any computer or similar product that may be capable, after a complicated processes, of storing similar type of data from a phone. However, any such computer would not have the portability of the device 10 that is achievable due to the device's 10 small dimensions. These dimensions make it simple to carry the device 10 in a user's pocket or any carrying pouch or purse. The selection mechanism 20 further makes the device 10 very simple to use. Either by pushing one of two buttons, in one embodiment, or a single button, in alternative embodiments, the user may easily transfer data between a mobile phone and the device 10. It is this single 1 step type of use this makes the device 10 simple to use. In an even further embodiment, no button needs to be used, since the selection mechanism may be incorporated directly into an input/output port (see FIG. 2) to automatically initiate transferring data either to or from a mobile phone upon porting the device 10 on a mobile phone. In this embodiment, the act of placing the input/output port (FIG. 2) in connection with a second port on the mobile phone or other device, will automatically trigger the transfer of information from the device to the mobile phone or vice versa. Again, any selection mechanism may be utilized to simply transfer data between the device 10 and the mobile phone. Due to the small size of the device, users may also be able to routinely carry the device 10 with them at all times in order to exchange data with other through the device 10. Thus, for example, a user may provide his or her contact information to another by simply placing the device 10 on another's mobile phone (as shown in FIG. 3 below) and transferring data to the mobile phone using a selection mechanism. In this way, there is no need to carry paper business cards or other identifying information since the device 10 may transfer such information simply and conveniently.

Returning to FIG. 1, the device 10 has a port cover 35 that is used to protect the input/output port 40 of FIG. 2. The protection is used to keep environmental contaminants such as dust or debris from damaging the port 40 and also to allow for convenient enclosure of the device 10 when not in use. The port cover 35 may be made from similar materials as the housing 15. The port cover 35 is secured by grooves 45 that expand and contract around the housing 15 to secure the port cover 35 to the housing 15. It is understood that other securing mechanisms may be used to secure the port cover 35 such as clasps, snaps and the like. A release button 50 on the device 10 allows the device 10 to be released from a mobile phone when the data transfer is complete by depressing the release button 50.

FIG. 2 is a perspective view of a further embodiment of the portable data loading device of the present invention. In this FIG. 2, the port cover 35 has been released from the housing 15. The input/output port 40 is exposed by removing the port cover 35. The port 40 may be any known input/output connector. For example, the port 40 may be a serial port, a parallel port, a universal serial bus, infra-red data transfer or even wireless (radio frequency) data transfer. In further embodiments, the port 40 may include a cable that couples the device 10 to a mobile phone rather than a port that is in direct connection to the mobile phone.

FIG. 3 is a perspective view of an embodiment of the portable data loading device of the present invention in use with a mobile phone. In use, the device 10 (without the port cover 35) is connected to the mobile phone 55 by engaging the port 40 to a port on the mobile phone 55. Once the device 10 is connected directly to the mobile phone 55, the selection mechanism 20 may be engaged (e.g. by depressing first 25 and second 30 buttons in one embodiment) to transfer data to and from the mobile phone. It is understood that the device 10 need not only be connected to a mobile phone 55, but may also be connected to a second data loading device such as a personal digital assistant, a computer or a land phone, all such devices being well known in the art. Again, all the advantages of the size, portability and simplicity of use are achieved even in use with the second data loading devices. To release the portable data loading device 10, the release button 50 is pressed to disengage the port 40 from the mobile phone 55.

FIG. 4 is a perspective view of a disassembled embodiment of the portable data loading device of the present invention. In FIG. 4, the selection mechanism 20 is shown apart from the housing 15 and the port cover 35. The port 40 is shown above a latch spring 60. The latch spring 60 is used to provide a resilient connection between the port 40 and the port of the mobile phone or a second data loading device. Also shown in FIG. 4 is an assembled printed circuit board (PCB) 65 that is a board that contains the electrical components for transferring data to and from the device 10. Then the housing bottom 70 and the release button 50 are shown.

FIGS. 5A-5C are top, side and bottom views, respectively, of an embodiment of the board of the portable data loading device of the present invention. In FIG. 5A, the top of the board 65 is shown. The board 65 of the device 10 is located in the housing 15. The board 65 has a data storage device 85 that contains the data that is transferred to and from the mobile phone. In one embodiment, the data storage device is a non-volatile memory device such as a flash memory device. In other embodiments, the data storage device may be any device that stores and retrieves data. In one embodiment, the storage device is a flash memory device manufactured by ATMEI with Model No. AT45 DB02113. Also on the board 65 is a microcontroller 80 that controls the transfer of data to and from the data storage device 85 and a mobile phone. The microcontroller may be any conventional microcontroller or microprocessor. For example, the microcontroller 80 may be manufactured by ATMEI with Model No. ATMEGA6L. The board 65 further has tact switches 90 which are mechanical switches to initiate data transfer or loading. Light emitting diodes 95 provide status indication of the data transfer or loading. FIG. 5B is a side view of the board 65 showing the similar structures of FIG. 5A. FIG. 5C likewise provides a bottom view of the board 65 and shows a crystal 100 used to operate the microcontroller 80.

It will be understood that the above-described embodiments are merely illustrative of applications of the principles of this invention and many other embodiments and modifications may be made without departing from the spirit and scope of the invention as defined in the claims.

What is claimed is:

1. A portable data loading device for transferring data to and from a mobile phone, comprising:
a housing;
a board within the housing, the board comprising
a data storage device for storing data being transferred to and from the mobile phone; and
a microcontroller for controlling the transfer of data to and from the mobile phone;
a selection mechanism in communication with the board for selecting between the transfer of data to the mobile phone from the portable data loading device or the transfer of data from the mobile phone to the portable data loading device; and
an input/output port in communication with the board to directly engage the portable data loading device to the mobile phone.

2. The portable data loading device of claim 1 wherein the selection mechanism comprises
a first button, the first button being depressed to transfer data to the mobile phone from the portable data loading device; and
a second button, the second button being depressed to transfer data from the mobile phone to the portable data loading device.

3. The portable data loading device of claim 1 wherein the selection mechanism comprises
a single button, the single button being depressed in a first sequence to transfer data to the mobile phone from the portable data loading device and the single button being depressed in a second sequence to transfer data from the mobile phone to the portable data loading device.

4. The portable data loading device of claim 3, wherein the first sequence further comprises depressing the single button for an amount of time that is distinguishable from the an amount of time for depressing the single button for the second sequence.

5. The portable data loading device of claim 3, wherein the first sequence further comprises depressing the single button for a number of times that is distinguishable from a number of times for depressing the single button for the second sequence.

6. The portable data loading device of claim 1 wherein the selection mechanism comprises
the input/output port; and
a second port located outside the portable data loading device, wherein coupling the input/output port to the second port automatically selects between the transfer of data to the mobile phone from the portable data loading device or the transfer of data from the mobile phone to the portable data loading device.

7. The portable data loading device of claim 1 wherein the input/output port comprises a serial port.

8. The portable data loading device of claim 1 wherein the input/output port comprises a parallel port.

9. The portable data loading device of claim 1 wherein the input/output port comprises a universal serial bus.

10. The portable data loading device of claim 1 wherein the input/output port comprises a cable for coupling the portable data loading device to the mobile phone.

11. The portable data loading device of claim 1 wherein the data comprises user-defined information and mobile phone identification information.

12. The portable data loading device of claim 11 wherein the user-defined information comprises speed dialing information and data defining a user's preferred settings of the mobile phone.

13. The portable data loading device of claim 11 wherein the mobile phone identification information comprises information that uniquely identifies the mobile phone.

14. A portable data loading device for transferring data to and from a second data loading device, comprising:
a housing;
a board within the housing, the board comprising
a data storage device for storing data being transferred to and from the second data loading device; and
a microcontroller for controlling the transfer of data to and from the second data loading device;
a selection mechanism in communication with the board for selecting between the transfer of data to the second data loading device from the portable data loading device or the transfer of data from the second data loading device to the portable data loading device; and
an input/output port in communication with the board to directly engage the portable data loading device to the second data loading device.

15. The portable data loading device of claim 14 wherein the second data loading device is a personal digital assistant.

16. The portable data loading device of claim 14 wherein the second data loading device is a computer.

17. The portable data loading device of claim 14 wherein the second data loading device is a land phone.

18. A method of transferring data between a portable data loading device and a mobile phone, comprising:
providing the portable data loading device, the portable data loading device comprising:
a housing;
a board within the housing, the board comprising
a data storage device for storing data being transferred to and from the mobile phone; and
a microcontroller for controlling the transfer of data to and from the mobile phone;
a selection mechanism in communication with the board for selecting between the transfer of data to the mobile phone from the portable data loading device or the transfer of data from the mobile phone to the portable data loading device; and
an input/output port in communication with the board to directly engage the portable data loading device to the mobile phone;
connecting the portable data loading device directly to the mobile phone through the input/output port; and
engaging the selection mechanism to transfer data to or from the mobile phone.

19. The method of claim 18 wherein the step of engaging the selection mechanism further comprising:
depressing a first button to transfer data to the mobile phone from the portable data loading device; and
depressing a second button to transfer data from the mobile phone to the portable data loading device.

20. The method of claim 18 wherein the step of engaging the selection mechanism further comprising:
depressing a single button in a first sequence to transfer data to the mobile phone from the portable data loading device; and
depressing the single button in a second sequence to transfer data from the mobile phone to the portable data loading device.

21. The method of claim 20 wherein the step of engaging the selection mechanism further comprising:
depressing the single button during the first sequence for an amount of time that is distinguishable from the an amount of time for depressing the single button for the second sequence.

22. The method of claim 20 wherein the step of engaging the selection mechanism further comprising:
depressing the single button during the first sequence for a predetermined number of times that is distinguishable from the a predetermined number of times for depressing the single button for the second sequence.
